(19) United States
(12) Patent Application Publication
(10) Pub. No.: US 2017/0289724 A1
(43) Pub. Date: Oct. 5, 2017

(54) RENDERING AUDIO OBJECTS IN A REPRODUCTION ENVIRONMENT THAT INCLUDES SURROUND AND/OR HEIGHT SPEAKERS

(71) Applicants: DOLBY LABORATORIES LICENSING CORPORATION, San Francisco, CA (US); DOLBY INTERNATIONAL AB, Amsterdam Zuidoost (NL)

(72) Inventors: Dirk Jeroen BREEBAART, Ultimo (AU); Antonio Mateos SOLE, Barcelona (ES); Heiko PURNHAGEN, Sundbyberg (SE); Nicolas R. TSINGOS, San Francisco, CA (US)

(73) Assignees: DOLBY LABORATORIES LICENSING CORPORATION, San Francisco, CA (US); DOLBY INTERNATIONAL AB, Amsterdam Zuidoost (NL)

(21) Appl. No.: 15/510,213

(22) PCT Filed: Sep. 10, 2015
(86) PCT No.: PCT/US2015/049416

§ 371 Date: Mar. 9, 2017

Related U.S. Application Data
(60) Provisional application No. 62/079,265, filed on Nov. 13, 2014.

(30) Foreign Application Priority Data
Sep. 12, 2014 (ES) P201431322

(51) Int. Cl. H04S 7/00; H04R 3/12

(52) U.S. Cl. CPC H04S 7/30; H04R 3/12; H04S 2400/03; H04S 2400/11

(57) ABSTRACT

During a process, decorrelation may be selectively applied to audio data for an audio object based, at least in part, on whether a speaker for which speaker feed signals will be determined is a surround speaker. In some implementations, decorrelation may be selectively applied according to whether such a speaker is a height speaker. Some implementations may reduce, or even eliminate, audio artifacts such as comb-filter notches and peaks. Some such implementations may increase the size of a “sweet spot” of a reproduction environment.

### CROSS REFERENCE TO RELATED APPLICATIONS

This application claims priority to Spanish Patent Application No. P201431322, filed on Sep. 12, 2014 and U.S. Provisional Patent Application No. 62/079,265, filed on Nov. 13, 2014, each of which is hereby incorporated by reference in its entirety.

### TECHNICAL FIELD

This disclosure relates to authoring and rendering of audio reproduction data. In particular, this disclosure relates to authoring and rendering audio reproduction data for reproduction environments such as cinema sound reproduction systems.

### BACKGROUND

Since the introduction of sound with film in 1927, there has been a steady evolution of technology used to capture the artistic intent of the motion picture sound track and to replay it in a cinema environment. In the 1930s, synchronized sound on disc gave way to variable area sound on film, which was further improved in the 1940s with theatrical acoustic considerations and improved loudspeaker design, along with early introduction of multi-track recording and steerable replay (using control tones to move sounds). In the 1950s and 1960s, magnetic striping of film allowed multi-channel playback in theatre, introducing surround channels and up to five screen channels in premium theatres.

In the 1970s Dolby introduced noise reduction, both in post-production and on film, along with a cost-effective means of encoding and distributing mixes with 3 screen channels and a mono surround channel. The quality of cinema sound was further improved in the 1980s with Dolby Spectral Recording (SR) noise reduction and certification programs such as THX. Dolby brought digital sound to the cinema during the 1990s with a 5.1 channel format that provides discrete left, center and right screen channels, left and right surround arrays and a subwoofer channel for low-frequency effects. Dolby Surround 7.1, introduced in 2010, increased the number of surround channels by splitting the existing left and right surround channels into four “zones.”

As the number of channels increases and the loudspeaker layout transitions from a planar two-dimensional (2D) array to a three-dimensional (3D) array including height speakers, the tasks of authoring and rendering sounds are becoming increasingly complex. Improved methods and devices would be desirable.

### SUMMARY

Some aspects of the subject matter described in this disclosure can be implemented in tools for rendering audio reproduction data that includes audio objects created without reference to any particular reproduction environment. As used herein, the term “audio object” may refer to a stream of audio object signals and associated audio object metadata. The metadata may indicate at least the position of the audio object. However, the metadata also may indicate decorrelation data, rendering constraint data, content type data (e.g. dialog, effects, etc.), gain data, trajectory data, etc. Some audio objects may be static, whereas others may have time-varying metadata: such audio objects may move, may change size and/or may have other properties that change over time.

When audio objects are monitored or played back in a reproduction environment, the audio objects may be rendered according to at least the audio object position data. The rendering process may involve computing a set of audio object gain values for each channel of a set of output channels. Each output channel may correspond to one or more reproduction speakers of the reproduction environment. Accordingly, the rendering process may involve rendering the audio objects into one or more speaker feed signals based, at least in part, on audio object metadata. The speaker feed signals may correspond to reproduction speaker locations within the reproduction environment.

As described in detail herein, in some implementations a method may involve receiving audio data that includes audio objects. The audio objects may include audio object signals and associated audio object metadata. The audio object metadata may include at least audio object position data. The method may involve receiving reproduction environment data that may include an indication of a number of reproduction speakers in a reproduction environment and indications of reproduction speaker locations within the reproduction environment. The method may involve rendering the audio objects into one or more speaker feed signals based, at least in part, on the audio object metadata. Each speaker feed signal may correspond to at least one of the reproduction speakers within the reproduction environment.

The rendering may involve determining, based at least in part on audio object position data for an audio object, a plurality of reproduction speakers for which speaker feed signals will be rendered. The rendering may involve determining, based at least in part on whether at least one reproduction speaker of the plurality of reproduction speakers for which speaker feed signals will be rendered is a surround speaker or a height speaker, an amount of decorrelation to apply to audio object signals corresponding to the audio object. The decorrelation may involve mixing an audio signal and a decorrelated version of the audio signal.

According to some implementations, if it is determined that no reproduction speaker of the plurality of reproduction speakers for which speaker feed signals will be rendered is a surround speaker or a height speaker, determining the amount of decorrelation to apply may involve determining that no decorrelation will be applied. In some examples, determining the amount of decorrelation to apply may be based, at least in part, on audio object position data corresponding to the audio object.

In some implementations, the audio object metadata associated with at least some of the audio objects may include information regarding the amount of decorrelation to apply. Alternatively, or additionally, determining the amount of decorrelation to apply may be based, at least on part, on a user-defined parameter.

At least some of the audio objects may be static audio objects. However, at least some of the audio objects may be dynamic audio objects that have time-varying metadata, such as time-varying position data.

In some examples, the reproduction environment may be a cinema sound system environment or a home theater environment. The reproduction environment may, for example, include a Dolby Surround 5.1 configuration or a Dolby Surround 7.1 configuration. In some implementations wherein the reproduction environment includes a Dolby Surround 5.1 configuration, determining an amount of decorrelation to apply may involve determining whether rendering the audio objects will involve panning across a left front/left surround speaker pair or a right front/right surround speaker pair. In some implementations wherein the reproduction environment includes a Dolby Surround 7.1 configuration, determining an amount of decorrelation to apply may involve determining whether rendering the audio objects will involve panning across a left front/left side surround speaker pair, a left side surround/left rear surround speaker pair, a right front/right side surround speaker pair or a right side surround/right rear surround speaker pair.

At least some aspects of this disclosure may be implemented in an apparatus that includes an interface system and a logic system. The logic system may include at least one of a general purpose single- or multi-chip processor, a digital signal processor (DSP), an application specific integrated circuit (ASIC), a field programmable gate array (FPGA) or other programmable logic device, discrete gate or transistor logic, or discrete hardware components. The interface system may include a network interface. In some implementations, the apparatus may include a memory system. The interface system may include an interface between the logic system and at least a portion of (e.g., at least one memory device of) the memory system.

The logic system may be capable of receiving, via the interface system, audio data that includes audio objects. The audio objects may include audio object signals and associated audio object metadata. The audio object metadata may include at least audio object position data.

The logic system may be capable of receiving reproduction environment data that includes an indication of a number of reproduction speakers in a reproduction environment and indications of reproduction speaker locations within the reproduction environment. The logic system may be capable of rendering the audio objects into one or more speaker feed signals based, at least in part, on the audio object metadata. Each speaker feed signal may correspond to at least one of the reproduction speakers within the reproduction environment.

The rendering may involve determining, based at least in part on audio object position data for an audio object, a plurality of reproduction speakers for which speaker feed signals will be rendered. The rendering may involve determining, based at least in part on whether at least one reproduction speaker of the plurality of reproduction speakers for which speaker feed signals will be rendered is a surround speaker or a height speaker, an amount of decorrelation to apply to audio object signals corresponding to the audio object.

In some implementations, if it is determined that no reproduction speaker of the plurality of reproduction speakers for which speaker feed signals will be rendered is a surround speaker or a height speaker, determining the amount of decorrelation to apply may involve determining that no decorrelation will be applied. In some examples, determining the amount of decorrelation to apply may be based, at least in part, on audio object position data corresponding to the audio object. In some implementations, the audio object metadata associated with at least some of the audio objects may include information regarding the amount of decorrelation to apply. Alternatively, or additionally, determining the amount of decorrelation to apply may be based, at least on part, on a user-defined parameter. The decorrelation may involve mixing an audio signal and a decorrelated version of the audio signal.

At least some of the audio objects may be static audio objects. However, at least some of the audio objects may be dynamic audio objects that have time-varying metadata, such as time-varying position data.

In some examples, the reproduction environment may be a cinema sound system environment or a home theater environment. The reproduction environment may include a Dolby Surround 5.1 configuration or a Dolby Surround 7.1 configuration. In some implementations wherein the reproduction environment includes a Dolby Surround 5.1 configuration, determining an amount of decorrelation to apply may involve determining whether rendering the audio objects will involve panning across a left front/left surround speaker pair or a right front/right surround speaker pair. In some implementations wherein the reproduction environment includes a Dolby Surround 7.1 configuration, determining an amount of decorrelation to apply may involve determining whether rendering the audio objects will involve panning across a left front/left side surround speaker pair, a left side surround/left rear surround speaker pair, a right front/right side surround speaker pair or a right side surround/right rear surround speaker pair.

Some or all of the methods described herein may be performed by one or more devices according to instructions (e.g., software) stored on non-transitory media. Such non-transitory media may include memory devices such as those described herein, including but not limited to random access memory (RAM) devices, read-only memory (ROM) devices, etc. For example, the software may include instructions for controlling one or more devices for receiving audio data including one or more audio objects. The audio objects may include audio object signals and associated audio object metadata. The audio object metadata may include at least audio object position data.

The software may include instructions for receiving reproduction environment data that includes an indication of a number of reproduction speakers in a reproduction environment and indications of reproduction speaker locations within the reproduction environment and for rendering the audio objects into one or more speaker feed signals based, at least in part, on the audio object metadata, wherein each speaker feed signal corresponds to at least one of the reproduction speakers within the reproduction environment. The rendering may involve determining, based at least in part on audio object position data for an audio object, a plurality of reproduction speakers for which speaker feed signals will be rendered and determining, based at least in part on whether at least one reproduction speaker of the plurality of reproduction speakers for which speaker feed signals will be rendered is a surround speaker or a height speaker, an amount of decorrelation to apply to audio object signals corresponding to the audio object.

If it is determined that no reproduction speaker of the plurality of reproduction speakers for which speaker feed signals will be rendered is a surround speaker or a height speaker, determining the amount of decorrelation to apply may involve determining that no decorrelation will be applied. In some examples, determining the amount of decorrelation to apply may be based, at least in part, on audio object position data corresponding to the audio object. In some implementations, the audio object metadata associated with at least some of the audio objects may include information regarding the amount of decorrelation to apply. Alternatively, or additionally, determining the amount of decorrelation to apply may be based, at least on part, on a user-defined parameter. The decorrelation may involve mixing an audio signal and a decorrelated version of the audio signal.

At least some of the audio objects may be static audio objects. However, at least some of the audio objects may be dynamic audio objects that have time-varying metadata, such as time-varying position data.

In some examples, the reproduction environment may be a cinema sound system environment or a home theater environment. The reproduction environment may include a Dolby Surround 5.1 configuration or a Dolby Surround 7.1 configuration. In some implementations wherein the reproduction environment includes a Dolby Surround 5.1 configuration, determining an amount of decorrelation to apply may involve determining whether rendering the audio objects will involve panning across a left front/left surround speaker pair or a right front/right surround speaker pair. In some implementations wherein the reproduction environment includes a Dolby Surround 7.1 configuration, determining an amount of decorrelation to apply may involve determining whether rendering the audio objects will involve panning across a left front/left side surround speaker pair, a left side surround/left rear surround speaker pair, a right front/right side surround speaker pair or a right side surround/right rear surround speaker pair.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a reproduction environment having a Dolby Surround 5.1 configuration.

FIG. 2 shows an example of a reproduction environment having a Dolby Surround 7.1 configuration.

FIGS. 3A and 3B illustrate two examples of home theater playback environments that include height speaker configurations.

FIG. 4A shows an example of a graphical user interface (GUI) that portrays speaker zones at varying elevations in a virtual reproduction environment.

FIG. 4B shows an example of another reproduction environment.

FIGS. 5A and 5B show examples of left/right panning and front/back panning in a reproduction environment.

FIG. 6 is a block diagram that provides examples of components of an apparatus capable of implementing various methods described herein.

FIG. 7 is a flow diagram that provides examples of audio processing operations.

FIG. 8 provides an example of selectively applying decorrelation to speaker pairs in a reproduction environment.

FIG. 9 is a block diagram that provides examples of components of an authoring and/or rendering apparatus.

Like reference numbers and designations in the various drawings indicate like elements.

### DESCRIPTION OF EXAMPLE EMBODIMENTS

The following description is directed to certain implementations for the purposes of describing some innovative aspects of this disclosure, as well as examples of contexts in which these innovative aspects may be implemented. However, the teachings herein can be applied in various different ways. For example, while various implementations have been described in terms of particular reproduction environments, the teachings herein are widely applicable to other known reproduction environments, as well as reproduction environments that may be introduced in the future. Moreover, the described implementations may be implemented in various authoring and/or rendering tools, which may be implemented in a variety of hardware, software, firmware, etc. Accordingly, the teachings of this disclosure are not intended to be limited to the implementations shown in the figures and/or described herein, but instead have wide applicability.

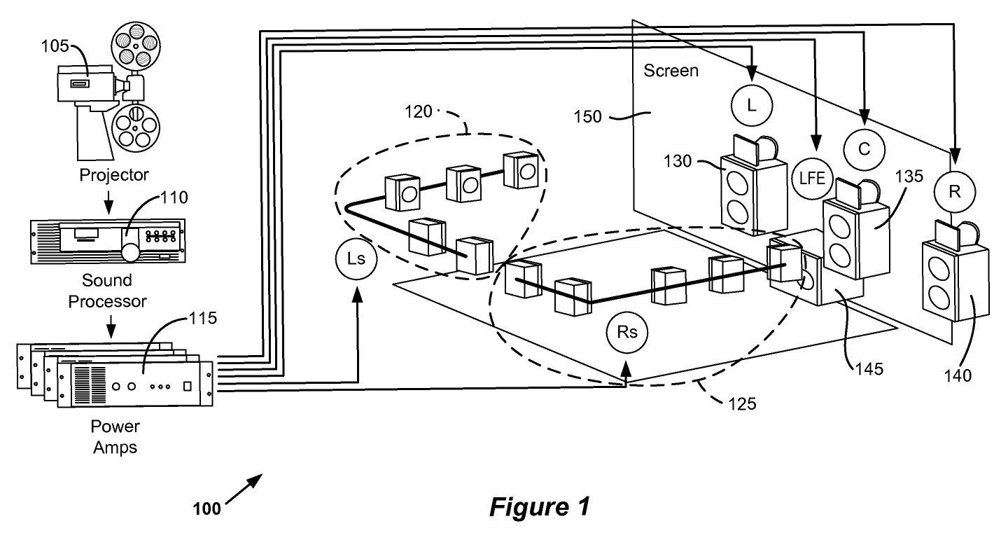

FIG. 1 shows an example of a reproduction environment having a Dolby Surround 5.1 configuration. Dolby Surround 5.1 was developed in the 1990s, but this configuration is still widely deployed in cinema sound system environments. A projector 105 may be configured to project video images, e.g. for a movie, on the screen 150. Audio reproduction data may be synchronized with the video images and processed by the sound processor 110. The power amplifiers 115 may provide speaker feed signals to speakers of the reproduction environment 100.

The Dolby Surround 5.1 configuration includes left surround array 120 and right surround array 125, each of which includes a group of speakers that are gang-driven by a single channel. The Dolby Surround 5.1 configuration also includes separate channels for the left screen channel 130, the center screen channel 135 and the right screen channel 140. A separate channel for the subwoofer 145 is provided for low-frequency effects (LFE).

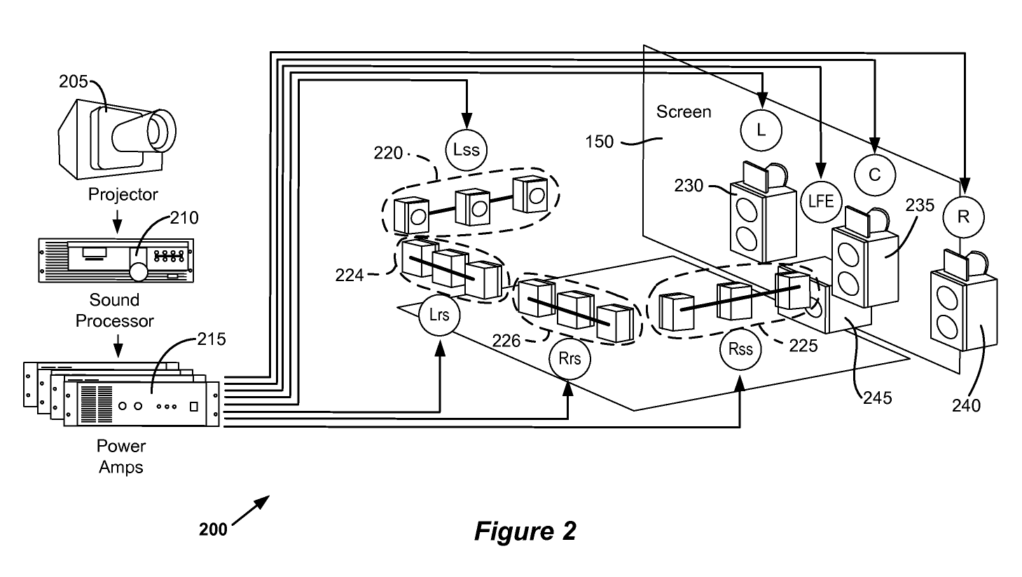

In 2010, Dolby provided enhancements to digital cinema sound by introducing Dolby Surround 7.1. FIG. 2 shows an example of a reproduction environment having a Dolby Surround 7.1 configuration. A digital projector 205 may be configured to receive digital video data and to project video images on the screen 150. Audio reproduction data may be processed by the sound processor 210. The power amplifiers 215 may provide speaker feed signals to speakers of the reproduction environment 200.

The Dolby Surround 7.1 configuration includes the left side surround array 220 and the right side surround array 225, each of which may be driven by a single channel. Like Dolby Surround 5.1, the Dolby Surround 7.1 configuration includes separate channels for the left screen channel 230, the center screen channel 235, the right screen channel 240 and the subwoofer 245. However, Dolby Surround 7.1 increases the number of surround channels by splitting the left and right surround channels of Dolby Surround 5.1 into four zones: in addition to the left side surround array 220 and the right side surround array 225, separate channels are included for the left rear surround speakers 224 and the right rear surround speakers 226. Increasing the number of surround zones within the reproduction environment 200 can significantly improve the localization of sound.

In an effort to create a more immersive environment, some reproduction environments may be configured with increased numbers of speakers, driven by increased numbers of channels. Moreover, some reproduction environments may include speakers deployed at various elevations, some of which may be above a seating area of the reproduction environment.

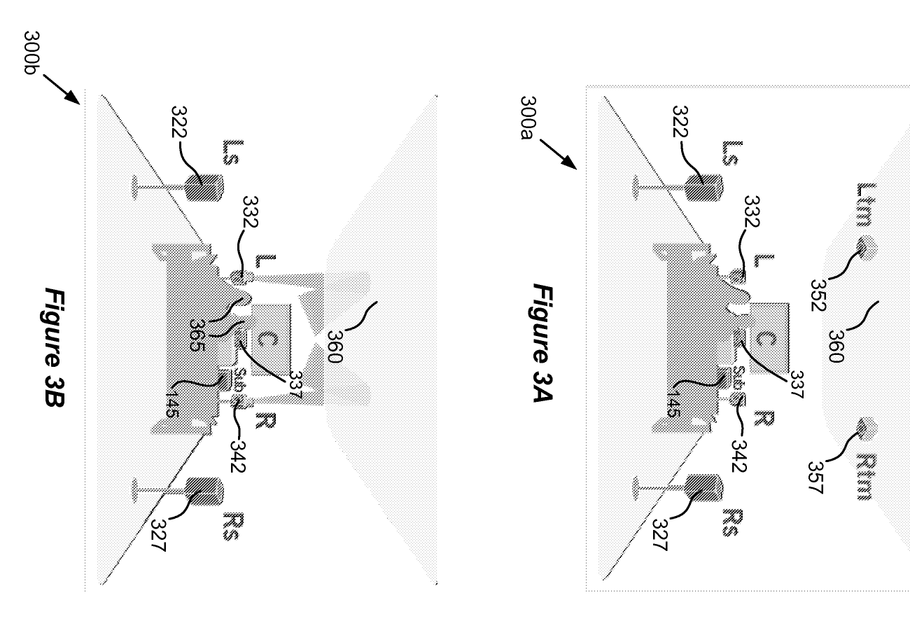

FIGS. 3A and 3B illustrate two examples of home theater playback environments that include height speaker configurations. In these examples, the playback environments 300a and 300b include the main features of a Dolby Surround 5.1 configuration, including a left surround speaker 322, a right surround speaker 327, a left speaker 332, a right speaker 342, a center speaker 337 and a subwoofer 145. However, the playback environment 300 includes an extension of the Dolby Surround 5.1 configuration for height speakers, which may be referred to as a Dolby Surround 5.1.2 configuration.

FIG. 3A illustrates an example of a playback environment having height speakers mounted on a ceiling 360 of a home theater playback environment. In this example, the playback environment 300a includes a height speaker 352 that is in a left top middle (Ltm) position and a height speaker 357 that is in a right top middle (Rtm) position. In the example shown in FIG. 3B, the left speaker 332 and the right speaker 342 are Dolby Elevation speakers that are configured to reflect sound from the ceiling 360. If properly configured, the reflected sound may be perceived by listeners 365 as if the sound source originated from the ceiling 360. However, the number and configuration of speakers is merely provided by way of example. Some current home theater implementations provide for up to 34 speaker positions, and contemplated home theater implementations may allow yet more speaker positions.

Accordingly, the modern trend is to include not only more speakers and more channels, but also to include speakers at differing heights. As the number of channels increases and the speaker layout transitions from a 2D array to a 3D array, the tasks of positioning and rendering sounds becomes increasingly difficult. Accordingly, the present assignee has developed various tools, as well as related user interfaces, which increase functionality and/or reduce authoring complexity for a 3D audio sound system.

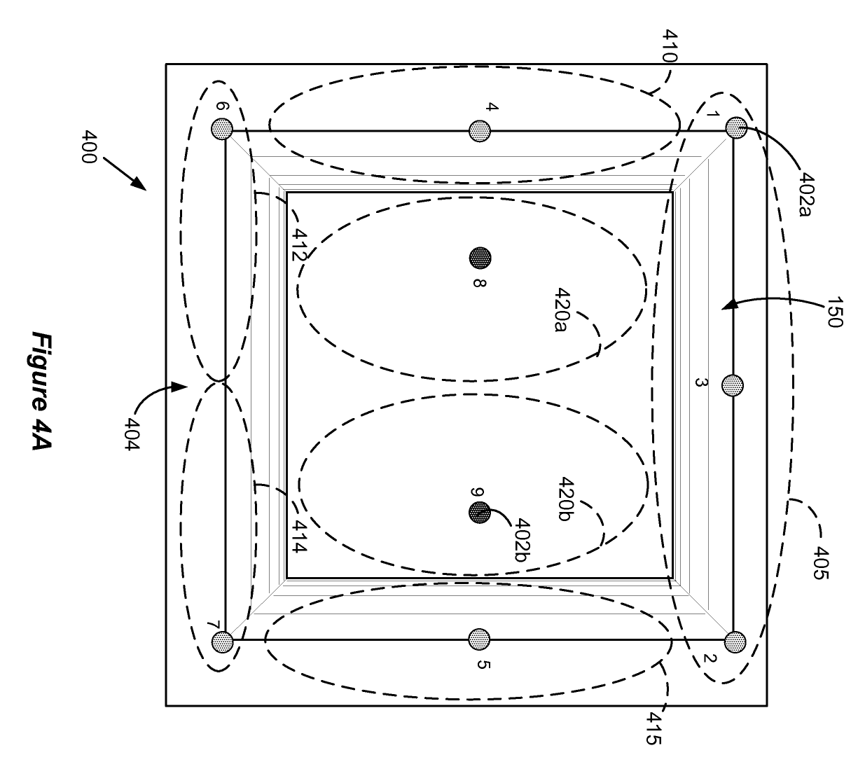

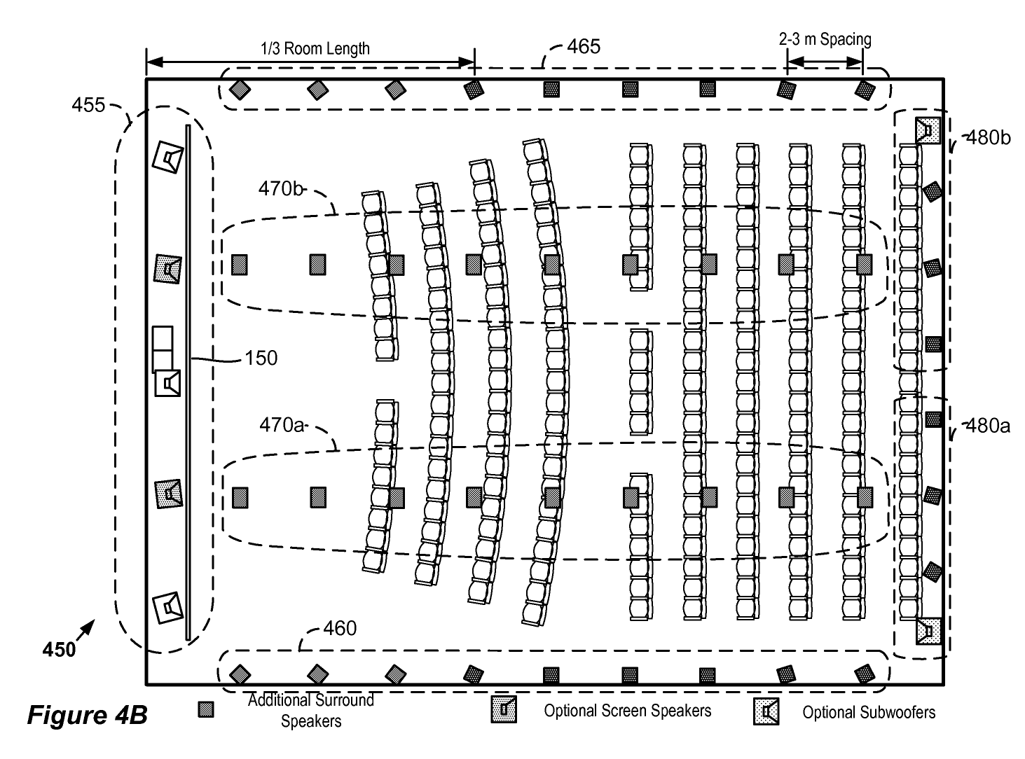

FIG. 4A shows an example of a graphical user interface (GUI) that portrays speaker zones at varying elevations in a virtual reproduction environment. GUI 400 may, for example, be displayed on a display device according to instructions from a logic system, according to signals received from user input devices, etc. Some such devices are described below with reference to FIG. 10.

As used herein with reference to virtual reproduction environments such as the virtual reproduction environment 404, the term “speaker zone” generally refers to a logical construct that may or may not have a one-to-one correspondence with a reproduction speaker of an actual reproduction environment. For example, a “speaker zone location” may or may not correspond to a particular reproduction speaker location of a cinema reproduction environment. Instead, the term “speaker zone location” may refer generally to a zone of a virtual reproduction environment. In some implementations, a speaker zone of a virtual reproduction environment may correspond to a virtual speaker, e.g., via the use of virtualizing technology such as Dolby Headphone,™ (sometimes referred to as Mobile Surround™), which creates a virtual surround sound environment in real time using a set of two-channel stereo headphones. In GUI 400, there are seven speaker zones 402a at a first elevation and two speaker zones 402b at a second elevation, making a total of nine speaker zones in the virtual reproduction environment 404. In this example, speaker zones 1-3 are in the front area 405 of the virtual reproduction environment 404. The front area 405 may correspond, for example, to an area of a cinema reproduction environment in which a screen 150 is located, to an area of a home in which a television screen is located, etc.

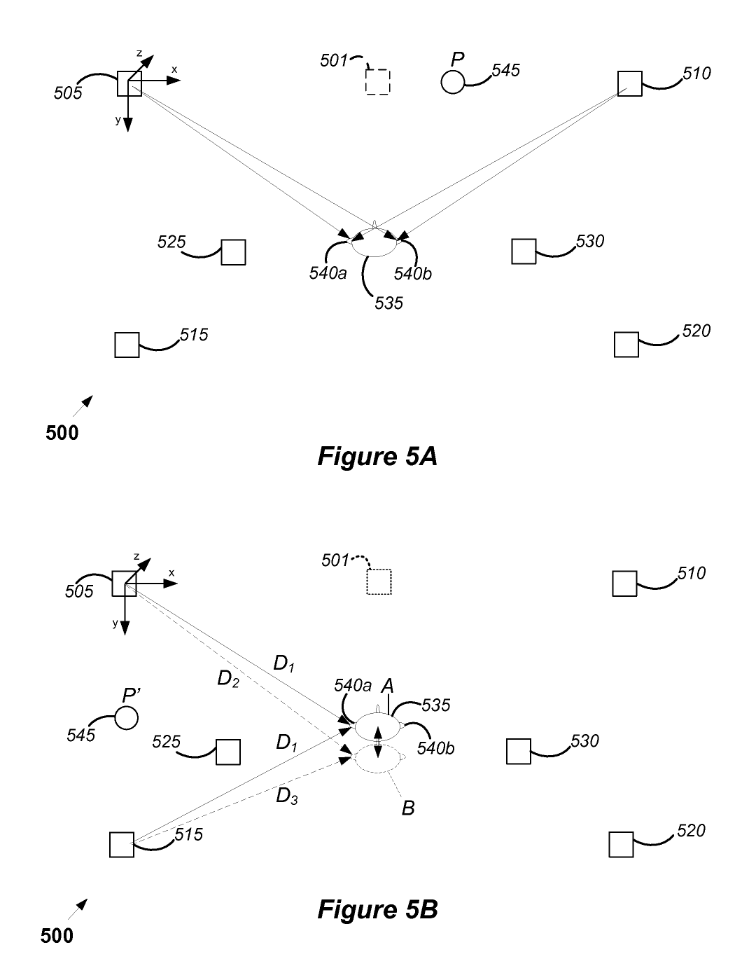

Here, speaker zone 4 corresponds generally to speakers in the left area 410 and speaker zone 5 corresponds to speakers in the right area 415 of the virtual reproduction environment 404. Speaker zone 6 corresponds to a left rear area 412 and speaker zone 7 corresponds to a right rear area 414 of the virtual reproduction environment 404. Speaker zone 8 corresponds to speakers in an upper area 420a and speaker zone 9 corresponds to speakers in an upper area 420b, which may be a virtual ceiling area such as an area of the virtual ceiling 520 shown in FIGS. 5D and 5E. Accordingly, the locations of speaker zones 1-9 that are shown in FIG. 4A may or may not correspond to the locations of reproduction speakers of an actual reproduction environment. Moreover, other implementations may include more or fewer speaker zones and/or elevations.

In various implementations, a user interface such as GUI 400 may be used as part of an authoring tool and/or a rendering tool. In some implementations, the authoring tool and/or rendering tool may be implemented via software stored on one or more non-transitory media. The authoring tool and/or rendering tool may be implemented (at least in part) by hardware, firmware, etc., such as the logic system and other devices described below with reference to FIG. 10. In some authoring implementations, an associated authoring tool may be used to create metadata for associated audio data. The metadata may, for example, include data indicating the position and/or trajectory of an audio object in a three-dimensional space, speaker zone constraint data, etc. The metadata may be created with respect to the speaker zones 402 of the virtual reproduction environment 404, rather than with respect to a particular speaker layout of an actual reproduction environment. A rendering tool may receive audio data and associated metadata, and may compute audio gains and speaker feed signals for a reproduction environment. Such audio gains and speaker feed signals may be computed according to an amplitude panning process, which can create a perception that a sound is coming from a position P in the reproduction environment. For example, speaker feed signals may be provided to reproduction speakers 1 through N of the reproduction environment according to the following equation:

xᵢ(t)=gᵢx(t),i=1, . . . N (Equation 1)

In Equation 1, xᵢ(t) represents the speaker feed signal to be applied to speaker gᵢ represents the gain factor of the corresponding channel, x(t) represents the audio signal and t represents time. The gain factors may be determined, for example, according to the amplitude panning methods described in Section 2, pages 3-4 of V. Pulkki, Compensating Displacement of Amplitude-Panned Virtual Sources (Audio Engineering Society (AES) International Conference on Virtual, Synthetic and Entertainment Audio), which is hereby incorporated by reference. In some implementations, the gains may be frequency dependent. In some implementations, a time delay may be introduced by replacing x(t) by x(t−Δt).

In some rendering implementations, audio reproduction data created with reference to the speaker zones 402 may be mapped to speaker locations of a wide range of reproduction environments, which may be in a Dolby Surround 5.1 configuration, a Dolby Surround 7.1 configuration, a Hamasaki 22.2 configuration, or another configuration. For example, referring to FIG. 2, a rendering tool may map audio reproduction data for speaker zones 4 and 5 to the left side surround array 220 and the right side surround array 225 of a reproduction environment having a Dolby Surround 7.1 configuration. Audio reproduction data for speaker zones 1, 2 and 3 may be mapped to the left screen channel 230, the right screen channel 240 and the center screen channel 235, respectively. Audio reproduction data for speaker zones 6 and 7 may be mapped to the left rear surround speakers 224 and the right rear surround speakers 226.

FIG. 4B shows an example of another reproduction environment. In some implementations, a rendering tool may map audio reproduction data for speaker zones 1, 2 and 3 to corresponding screen speakers 455 of the reproduction environment 450. A rendering tool may map audio reproduction data for speaker zones 4 and 5 to the left side surround array 460 and the right side surround array 465 and may map audio reproduction data for speaker zones 8 and 9 to left overhead speakers 470a and right overhead speakers 470b. Audio reproduction data for speaker zones 6 and 7 may be mapped to left rear surround speakers 480a and right rear surround speakers 480b.

In some authoring implementations, an authoring tool may be used to create metadata for audio objects. As noted above, the term “audio object” may refer to a stream of audio data signals and associated metadata. The metadata may indicate the 3D position of the audio object, the apparent size of the audio object, rendering constraints as well as content type (e.g. dialog, effects), etc. Depending on the implementation, the metadata may include other types of data, such as gain data, trajectory data, etc. Some audio objects may be static, whereas others may move. Audio object details may be authored or rendered according to the associated metadata which, among other things, may indicate the position of the audio object in a three-dimensional space at a given point in time. When audio objects are monitored or played back in a reproduction environment, the audio objects may be rendered according to their position and size metadata according to the reproduction speaker layout of the reproduction environment.

FIGS. 5A and 5B show examples of left/right panning and front/back panning in a reproduction environment. The locations of the speakers, numbers of speakers, etc., within the reproduction environment 500 are merely shown by way of example. As with other drawings of this disclosure, the elements of FIGS. 5A and 5B are not necessarily drawn to scale. The relative distances, angles, etc., between the elements shown are merely made by way of illustration.

In this example, the reproduction environment 500 includes a left speaker 505, a right speaker 510, a left surround speaker 515, a right surround speaker 520, a left height speaker 525 and a right height speaker 530. The listener's head 535 is facing towards a front area of the reproduction environment 500. Alternative implementations also may include a center speaker 501.

In this example, the left speaker 505, the right speaker 510, the left surround speaker 515 and the right surround speaker 520 are all positioned in an x,y plane. In this example, the left speaker 505 and the right speaker 510 are positioned along the x axis, whereas the left speaker 505 and the left surround speaker 515 are positioned along the y axis. Here, the left height speaker 525 and the right height speaker 530 are positioned above the listener's head 535, at an elevation z from the x,y plane. In this example, the left height speaker 525 and the right height speaker 530 are mounted on the ceiling of the reproduction environment 500.

In the example shown in FIG. 5A, the left speaker 505 and the right speaker 510 are producing sounds that correspond to the audio object 545, which is located at a position P in the reproduction environment 500. In this example, position P is in front of, and slightly to the right of, the listener's head 535. Here, P is also positioned along the x axis.

For example, a rendering tool may have received audio data and associated audio object metadata for the audio object 545, including audio object position data, and may have computed audio gains and speaker feed signals for the left speaker 505 and the right speaker 510 according to an amplitude panning process in order to create a perception that a sound source corresponding with the audio object 545 is at the position P. Such a sound source may be referred to herein as a “phantom image” or a “phantom source.”

In mathematical terms, a rendering or panning operation can be described as follows:

sᵢ(t)=Σⱼg_{i,j}(t)xⱼ(t) (Equation 2)

In Equation 2, g_{i,j}(t) represents a set of time-varying panning gains, x(t) represents a set of audio object signals and sᵢ(t) represents a resulting set of speaker feed signals. In this formulation, the index i corresponds with a speaker and the index j is an audio object index. In some examples, the panning gains g_{i,j}(t) may be represented as follows:

g_{i,j}(t)= [symbol] (P,Mⱼ(t)) (Equation 3)

In Equation 3, P represents a set of speakers having speaker positions Pᵢ, Mⱼ(t) represents time-varying audio object metadata and [symbol] represents a panning law, also referred to herein as a panning algorithm or a panning method. A wide range of panning methods [symbol] are known by persons of ordinary skill in the art, which include, but are not limited to, the sine-cosine panning law, the tangent panning law and the sine panning law NS. Furthermore, multi-channel panning laws such as vector-based amplitude panning (VBAP) have been proposed for 2-dimensional and 3-dimensional panning.

A listener's brain can use differences in amplitude, as well as spectral and timing cues, in order to localize sound sources. For determining the left/right position of a sound source, as in the example of FIG. 5A, a listener's auditory system may analyze interaural time differences (ITD) and interaural level differences (ILD).

Here, for example, the sounds from the left speaker 505 reach the listener's left ear 540a earlier than the listener's right ear 540b. The listener's auditory system and brain may evaluate ITDs from phase delays at low frequencies (e.g., below 800 Hz) and from group delays at high frequencies (e.g., above 1600 Hz). Some humans can discern interaural time differences of 10 microseconds or less.

A head shadow or acoustic shadow is a region of reduced amplitude of a sound because it is obstructed by the head. Sound may have to travel through and around the head in order to reach an ear. In the example shown in FIG. 5A, sound from the right speaker 510 will have a higher level at the listener's right ear 540b than at the listener's left ear 540a, at least in part because the listener's head 535 shadows the listener's left ear 540a. The ILD caused by a head shadow is generally frequency-dependent: the ILD effect typically increases with increasing frequency.

The head shadow effect may cause not only a significant attenuation of overall intensity, but also may cause a filtering effect. These filtering effects of head shadowing can be an essential element of sound localization. A listener's brain may evaluate the relative amplitude, timbre, and phase of a sound heard by the listener's left and right ears, and may determine the apparent location of a sound source according to such differences. Some listeners may be able to determine the apparent location of a sound source with an accuracy of approximately 1 degree for sound sources that are in front of the listener. Panning algorithms can exploit the foregoing auditory effects in order to produce highly effective rendering of audio object locations in front of a listener, e.g., for audio object positions and/or movements along the x axis of the reproduction environment 500.

However, listeners generally have a far lower level of sound localization accuracy for sound sources that are along the side of a listener: a typical sound localization accuracy for lateral sound sources is within a range of about 15 degrees. This lower accuracy is caused, at least in part, by the relative paucity of binaural cues such as ITD and ILD. Therefore, successful panning of audio objects that are positioned to the side of a listener (or that are moving along lateral trajectories) can be relatively more challenging than panning audio objects that are located in front of a listener. For example, a perceived phantom source location can be ambiguous, or may be very different from the intended source location.

Panning audio objects that are positioned to the side of a listener can pose additional challenges. Referring to FIG. 5B, the left speaker 505 and the left surround speaker 515 are shown rendering sounds corresponding to an audio object 545 that has a position P′. The listener's head 535 is shown moving between positions A and B. The solid arrows from the left speaker 505 and the left surround speaker 515 represent sounds that reach the listener's left ear 540a when the listener's head 535 is in position A, whereas the dashed arrows represent sounds that reach the listener's left ear 540a when the listener's head 535 is in position B.

In this example, position A corresponds to a “sweet spot” of the reproduction environment 500, in which the sound waves from the left speaker 505 and the sound waves from the left surround speaker 515 both travel substantially the same distance to the listener's left ear 540a, which is represented as D₁ in FIG. 5B. Because the time required for corresponding sounds to travel from the left speaker 505 and the left surround speaker 515 to the listener's left ear 540a is substantially the same, when the listener's head 535 is positioned in the sweets spot the left speaker 505 and the left surround speaker 515 are “delay aligned” and no audio artifacts result.

However, when the listener's head 535 moves to position B, the sound waves from the left speaker 505 travel a distance D₂ to the listener's left ear 540a and the sound waves from the left surround speaker 515 travel a distance D₃ to the listener's left ear 540a. In this example, D₂ is sufficiently larger than D₃ that when in position B, the listener's head 535 is no longer in the sweet spot. When the listener's head 535 is in position B, or in another position in which speakers are not delay aligned, “combing” artifacts (also referred to herein as comb-filter notches and peaks) in the frequency content of audio signals will arise during front/back panning of an audio object, such as shown in FIG. 5B. Such combing artifacts can deteriorate the perceived timbre of a phantom source, such as one corresponding to the audio object 545 at position P′, and also can cause a collapse of the spaciousness of the overall audio scene.

The sweet spot for front/back panning in a reproduction environment is often quite small. Therefore, even small changes in the orientation and position of a listener's head can cause such comb-filter notches and peaks to shift in frequency. For example, if the listener in FIG. 5B were rocking back and forth in her seat, causing the listener's head 535 to move back and forth between positions A and B, comb-filter notches and peaks would disappear when the listener's head 535 is in position A, then reappear, shifting in frequency, as the listener's head 535 moves to and from position B.

Similar phenomena can occur if a listener's head is moved up and down. Referring to FIG. 5B, if the position P′ of the audio object 545 is sufficiently high (in this example, has a sufficient z component), a panning operation may involve computing audio gains and speaker feed signals for the left speaker 505, the left surround speaker 515 and the left height speaker 525. If the listener's head 535 were moved up and down (e.g., along the z axis, or substantially along the z axis), audio artifacts such as comb-filter notches and peaks may be produced, and may shift in frequency.

Some implementations disclosed herein provide solutions to the above-mentioned problems. According to some such implementations, decorrelation may be selectively applied according to whether a speaker for which speaker feed signals will be provided during a panning process is a surround speaker. In some implementations, decorrelation may be selectively applied according to whether such a speaker is a height speaker. Some implementations may reduce, or even eliminate, audio artifacts such as comb-filter notches and peaks. Some such implementations may increase the size of a “sweet spot” of a reproduction environment.

The disclosed implementations have additional potential benefits. Downmixing of rendered content (for example, from Dolby 5.1 to stereo) can cause an increase in the amplitude or “level” of audio objects that are panned across front and surround speakers. This effect results from the fact that panning algorithms are typically energy-preserving such that the sum of the squared panning gains equals one. In some implementations disclosed herein, the gain buildup associated with down-mixing rendered signals will be reduced, due to reduced correlation of speaker signals for a given audio object.

The perceived loudness of a phantom source depends on the panning gains and therefore the perceived position. The reason for this position-dependent loudness is also due the fact that most panning algorithms are energy-preserving. The acoustical summation, however, especially at low frequencies, will behave more like electrical addition than acoustical addition, because the delays of multiple speakers to a listener's ear are substantially identical and little or no head shadowing effect occurs. The net result is that a phantom image panned between speakers will generally be perceived as being louder than when that same source is panned at or near one of the actual speakers. In some implementations disclosed herein, the perceived loudness of moving objects may be more consistent across the spatial trajectory.

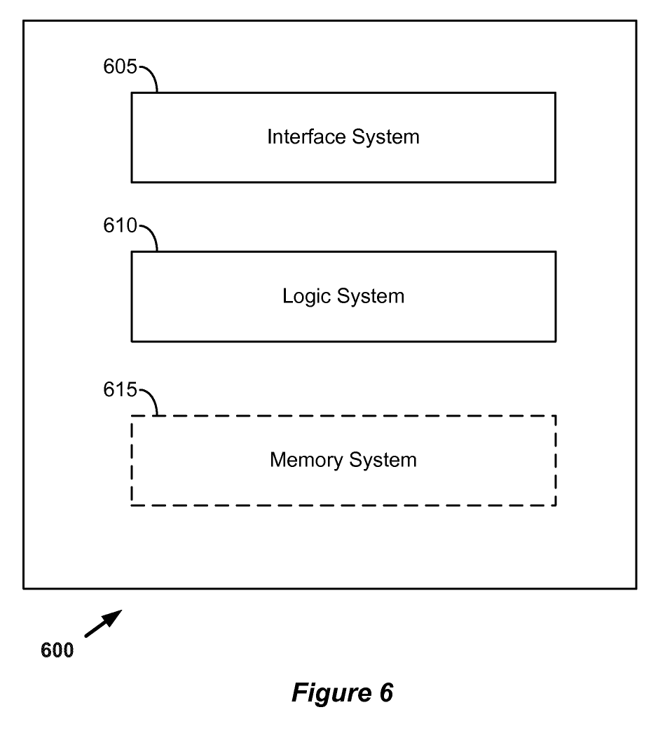

FIG. 6 is a block diagram that provides examples of components of an apparatus capable of implementing various methods described herein. The apparatus 600 may, for example, be (or may be a portion of) a theater sound system, a home sound system, etc. In some examples, the apparatus may be implemented in a component of another device.

In this example, the apparatus 600 includes an interface system 605 and a logic system 610. The logic system 610 may, for example, include a general purpose single- or multi-chip processor, a digital signal processor (DSP), an application specific integrated circuit (ASIC), a field programmable gate array (FPGA) or other programmable logic device, discrete gate or transistor logic, and/or discrete hardware components.

In this example, the apparatus 600 includes a memory system 615. The memory system 615 may include one or more suitable types of non-transitory storage media, such as flash memory, a hard drive, etc. The interface system 605 may include a network interface, an interface between the logic system and the memory system and/or an external device interface (such as a universal serial bus (USB) interface).

In this example, the logic system 610 is capable of receiving audio data and other information via the interface system 605. In some implementations, the logic system 610 may include (or may implement), a rendering apparatus. Accordingly, the logic system 610 may be capable of implementing some or all of the methods disclosed herein.

In some implementations, the logic system 610 may be capable of performing at least some of the methods described herein according to software stored one or more non-transitory media. The non-transitory media may include memory associated with the logic system 610, such as random access memory (RAM) and/or read-only memory (ROM). The non-transitory media may include memory of the memory system 615.

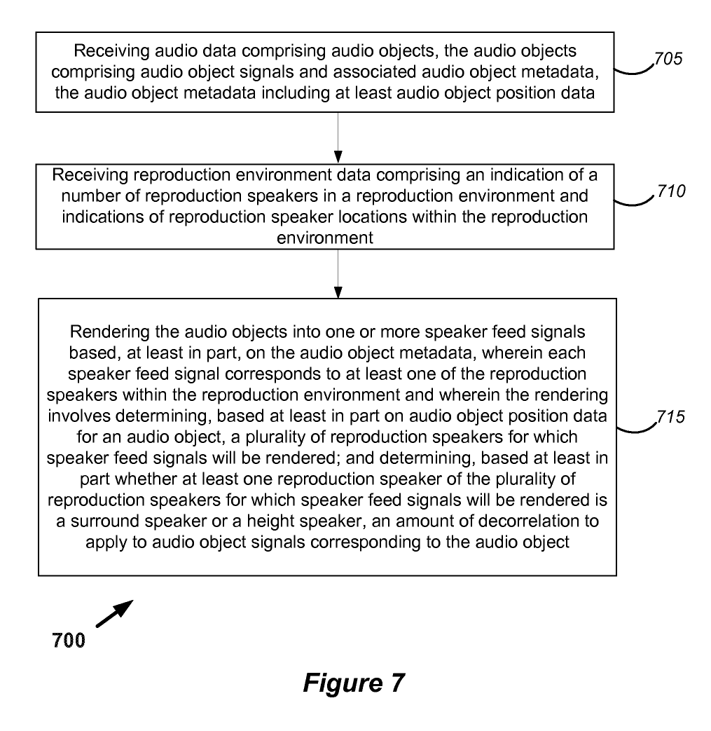

FIG. 7 is a flow diagram that provides examples of audio processing operations. The blocks of FIG. 7 (and those of other flow diagrams provided herein) may, for example, be performed by the logic system 610 of FIG. 6 or by a similar apparatus. As with other methods disclosed herein, the method outlined in FIG. 7 may include more or fewer blocks than indicated. Moreover, the blocks of methods disclosed herein are not necessarily performed in the order indicated.

Here, block 705 involves receiving audio data including audio objects. The audio objects may include audio object signals and associated audio object metadata. The audio object metadata may include at least audio object position data. Block 705 may involve receiving the audio data via an interface system such as the interface system 605 of FIG. 6. Accordingly, the blocks of FIG. 7 may be described with reference to implementations of one or more elements of FIG. 6.

In some examples, at least some of the audio objects received in block 705 may be static audio objects. However, at least some of the audio objects may be dynamic audio objects that have time-varying audio object metadata, e.g., audio object metadata that indicates time-varying audio object position data.

Block 710 may involve receiving reproduction environment data that includes an indication of a number of reproduction speakers in a reproduction environment and indications of reproduction speaker locations within the reproduction environment. In some examples, the reproduction environment data may be received along with the audio data. However, in some implementations the reproduction environment data may be received in another manner. For example, the reproduction environment data may be retrieved from a memory, such as a memory of the memory system 615 of FIG. 6.

In some instances, the indications of reproduction speaker locations may correspond with an intended layout of reproduction speakers in a reproduction environment. In some examples, the reproduction environment may be a cinema sound system environment. However in alternative examples, the reproduction environment may be a home theater environment or another type of reproduction environment. In some implementations, the reproduction environment may be configured according to an industry standard, e.g., a Dolby standard configuration, a Hamasaki configuration, etc. For example, the indications of reproduction speaker locations may correspond with left, right, center, surround and/or height speaker locations, e.g., of a Dolby Surround 5.1 configuration, a Dolby Surround 5.1.2 configuration (an extension of the Dolby Surround 5.1 configuration for height speakers, discussed above with reference to FIGS. 3A and 3B), a Dolby Surround 7.1 configuration, a Dolby Surround 7.1.2 configuration, or another reproduction environment configuration. In some implementations, the indications of reproduction speaker locations may include coordinates and/or other location information.

Block 715 involves a rendering process. In this example, block 715 involves rendering the audio objects into one or more speaker feed signals based, at least in part, on the audio object metadata. Each speaker feed signal may correspond to at least one of the reproduction speakers within the reproduction environment. For example, in some implementations a single reproduction speaker location (e.g., “left surround”) may correspond with multiple reproduction speakers of a reproduction environment. Some examples are shown in FIGS. 1 and 2, and are described above.

In the example shown in FIG. 7, the rendering process of block 715 involves determining, based at least in part on audio object position data for an audio object, a plurality of reproduction speakers for which speaker feed signals will be rendered. In this example, block 715 involves determining, based at least in part on whether at least one reproduction speaker of the plurality of reproduction speakers for which speaker feed signals will be rendered is a surround speaker or a height speaker, an amount of decorrelation to apply to audio object signals corresponding to the audio object.

The decorrelation process may be any suitable decorrelation process. For example, in some implementations the decorrelation process may involve applying a time delay, a filter, etc., to one or more audio signals. The decorrelation may involve mixing an audio signal and a decorrelated version of the audio signal.

If it is determined in block 715 that no reproduction speaker of the plurality of reproduction speakers for which speaker feed signals will be rendered is a surround speaker or a height speaker, determining an amount of decorrelation to apply may involve determining that no decorrelation will be applied. For example, if it is determined that the reproduction speakers for which speaker feed signals will be generated are a left (front) speaker and a center (front) speaker, in some implementations no decorrelation (or substantially no decorrelation) will be applied.

As noted above, for left/right panning, head shadow and other auditory effects will generally allow for accurate rendering of an audio object's location. Therefore, in some such implementations, no decorrelation (or substantially no decorrelation) will be applied for left/right panning. Instead, correlated speaker signals will be provided to the reproduction speakers. Accordingly, in such situations, the improved renderer disclosed herein and a legacy renderer may produce the same (or substantially the same) speaker feed signals.

However, if it is determined that at least one reproduction speaker for which speaker feed signals will be generated during the rendering process is a surround speaker or a height speaker, at least some amount of decorrelation will be applied to the audio object signals. For example, if the rendering process will involve generating speaker feed signals for a left surround speaker, some amount of decorrelation will be applied. Accordingly, in some such implementations, decorrelation will be applied for front/back panning. Decorrelated speaker signals will be provided to the reproduction speakers. Decorrelating the speaker signals may provide a reduced sensitivity to delay misalignment. Therefore, combing artifacts due to arrival time differences between front and surround speakers may be reduced or even completely eliminated. The size of the sweet spot may be increased. In some implementations, the perceived loudness of moving audio objects may be more consistent across the spatial trajectory.

If it is determined in block 715 that some amount of decorrelation will be applied, the amount of decorrelation may be based, at least in part, on audio object position data corresponding to the audio object. According to some implementations, for example, if the audio object position data indicate a position that coincides with any of the reproduction speaker locations, no decorrelation (or substantially no decorrelation) will be applied. In some examples, the audio object will be reproduced only by the reproduction speaker that has location that coincides with the audio object's position. Consequently, in such situations, the improved renderer disclosed herein and a legacy renderer may produce the same (or substantially the same) speaker feed signals.

In some implementations, an amount of decorrelation to apply may be based on other factors. For example, the audio object metadata associated with at least some of the audio objects may include information regarding the amount of decorrelation to apply. In some implementations, the amount of decorrelation to apply may be based, at least on part, on a user-defined parameter.

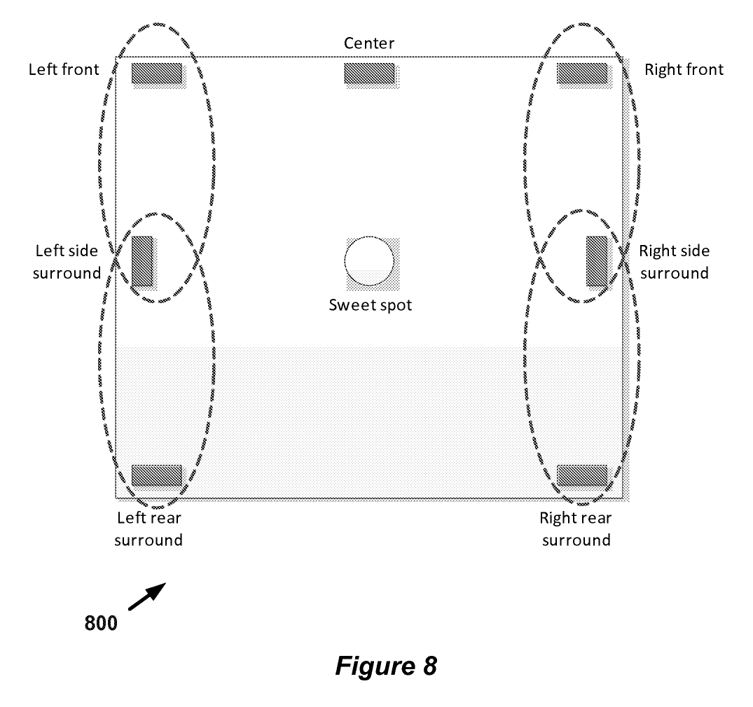

FIG. 8 provides an example of selectively applying decorrelation to speaker pairs in a reproduction environment. In this example, the reproduction environment is in a Dolby Surround 7.1 configuration. Here, dashed ovals are shown around speaker pairs for which, if involved in a rendering process, decorrelated speaker feed signals will be provided. Accordingly, in this example determining an amount of decorrelation to apply involves determining whether rendering the audio objects will involve panning across a left front/left side surround speaker pair, a left side surround/left rear surround speaker pair, a right front/right side surround speaker pair or a right side surround/right rear surround speaker pair.

In alternative examples, the reproduction environment may have a Dolby Surround 5.1 configuration. Determining an amount of decorrelation to apply may involve determining whether rendering the audio objects will involve panning across a left front/left surround speaker pair or a right front/right surround speaker pair.

According to some implementations, a rendering process may be performed according to the following formula:

sᵢ(t)=Σⱼg′_{i,j}(t)xⱼ(t)+Σⱼh_{i,j}(t)D(xⱼ(t)) (Equation 4)

In Equation 4, g′_{i,j}(t) and h_{i,j}(t) represent sets of time-varying panning gains, x(t) represents a set of audio object signals, D(xⱼ(t)) represents a decorrelation operator and sᵢ(t) represents a resulting set of speaker feed signals. As in Equation 2, above, the index i corresponds with a speaker and the index j is an audio object index. It may be observed that if D(xⱼ(t) and/or h_{i,j}(t) equals zero, Equation 4 yields the same result as Equation 2. Accordingly, in such circumstances the resulting speaker feed signals would be the same as those of a legacy panning algorithm in this example.

In some implementations, the effect of the decorrelation operator on an input signal y(t)=D(x(t)) may be represented as follows:

<x(t)y(t)>=0 (Equation 5)

<x²(t)>=<y²(t)> (Equation 6)

In Equations 5 and 6, x(t) represents an input signal, y(t) represents a corresponding output signal and the carats (< >) indicate expected values of the enclosed expressions.

According to some such implementations, the energy of an object reproduced by each loudspeaker using the decorrelation process is identical, or substantially identical, to the energy of the “legacy panner” of Equation 2. This condition may be represented as follows:

g_{i,j}²=g′_{i,j}²+h_{i,j}² (Equation 7)

Moreover, in some implementations, the contribution of the decorrelator cancels out when the speaker signals are downmixed. This condition may be represented as follows:

0=Σᵢh_{i,j} (Equation 8)

In some implementations, the amount of correlation (or decorrelation) between speaker pairs in the front/rear direction may be controllable. For example, the amount of correlation (or decorrelation) between speaker pairs may be set to a parameter p, e.g., as follows:

$$\frac{〈 {s}_{1} ( t ) {s}_{2} ( t ) 〉}{\sqrt{〈 {s}_{1} ( t ) {s}_{1} ( t ) 〉 〈 {s}_{2} ( t ) {s}_{2} ( t ) 〉}} = ρ \qquad ( Equation 9 )$$

In Equation 9, s₁ and s₂ represent two speakers of a speaker pair. Accordingly, such implementations can provide a seamless transition between the legacy panner of Equation 2 (e.g., wherein ρ=1, h_{i,j}=0) and some of the disclosed panner implementations that involve selectively applying decorrelation (e.g., wherein ρ<1).

Assuming pair-wise panning of signal x(t) between two speakers s₁, s₂, all criteria are satisfied when using the following formulation for the gains g′ and h:

$$\begin{matrix}{s}_{1} ( t ) = x ( t ) {g}_{1}^{′} + h 𝒟 ( x ( t ) ) = x ( t ) \sqrt{{g}_{1}^{2} - {h}^{2}} + h 𝒟 ( x ( t ) ) & ( Equation 10 ) \\ {s}_{2} ( t ) = x ( t ) {g}_{2}^{′} - h 𝒟 ( x ( t ) ) = x ( t ) \sqrt{{g}_{2}^{2} - {h}^{2}} - h 𝒟 ( x ( t ) ) & ( Equation 11 ) \\ {h}^{2} = \frac{( 1 - {ρ}^{2} ) {g}_{1}^{2} {g}_{2}^{2}}{{g}_{1}^{2} + {g}_{2}^{2} + 2 ρ {g}_{1} {g}_{2}} & ( Equation 12 )\end{matrix}$$

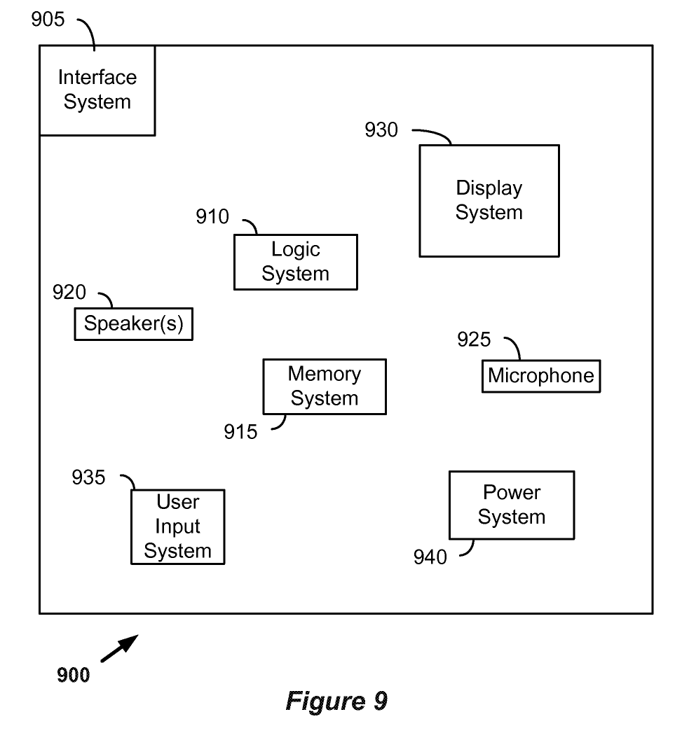

FIG. 9 is a block diagram that provides examples of components of an authoring and/or rendering apparatus. In this example, the device 900 includes an interface system 905. The interface system 905 may include a network interface, such as a wireless network interface. Alternatively, or additionally, the interface system 905 may include a universal serial bus (USB) interface or another such interface.

The device 900 includes a logic system 910. The logic system 910 may include a processor, such as a general purpose single- or multi-chip processor. The logic system 910 may include a digital signal processor (DSP), an application specific integrated circuit (ASIC), a field programmable gate array (FPGA) or other programmable logic device, discrete gate or transistor logic, or discrete hardware components, or combinations thereof. The logic system 910 may be configured to control the other components of the device 900. Although no interfaces between the components of the device 900 are shown in FIG. 9, the logic system 910 may be configured with interfaces for communication with the other components. The other components may or may not be configured for communication with one another, as appropriate.

The logic system 910 may be configured to perform audio authoring and/or rendering functionality, including but not limited to the types of audio rendering functionality described herein. In some such implementations, the logic system 910 may be configured to operate (at least in part) according to software stored in one or more non-transitory media. The non-transitory media may include memory associated with the logic system 910, such as random access memory (RAM) and/or read-only memory (ROM). The non-transitory media may include memory of the memory system 915. The memory system 915 may include one or more suitable types of non-transitory storage media, such as flash memory, a hard drive, etc.

The display system 930 may include one or more suitable types of display, depending on the manifestation of the device 900. For example, the display system 930 may include a liquid crystal display, a plasma display, a bistable display, etc.

The user input system 935 may include one or more devices configured to accept input from a user. In some implementations, the user input system 935 may include a touch screen that overlays a display of the display system 930. The user input system 935 may include a mouse, a track ball, a gesture detection system, a joystick, one or more GUIs and/or menus presented on the display system 930, buttons, a keyboard, switches, etc. In some implementations, the user input system 935 may include the microphone 925: a user may provide voice commands for the device 900 via the microphone 925. The logic system may be configured for speech recognition and for controlling at least some operations of the device 900 according to such voice commands.

The power system 940 may include one or more suitable energy storage devices, such as a nickel-cadmium battery or a lithium-ion battery. The power system 940 may be configured to receive power from an electrical outlet.

Various modifications to the implementations described in this disclosure may be readily apparent to those having ordinary skill in the art. The general principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1.-39. (canceled)

40. A method, comprising:
receiving audio data comprising audio objects, the audio objects comprising audio object signals and associated audio object metadata, the audio object metadata including at least audio object position data;
receiving reproduction environment data comprising an indication of a number of reproduction speakers in a reproduction environment and indications of reproduction speaker locations within the reproduction environment; and
rendering the audio objects into one or more speaker feed signals based, at least in part, on the audio object metadata, wherein each speaker feed signal corresponds to at least one of the reproduction speakers within the reproduction environment and wherein the rendering involves:
determining, based at least in part on audio object position data for an audio object among the audio objects, a plurality of reproduction speakers for which speaker feed signals will be rendered;
determining whether at least one reproduction speaker of the plurality of reproduction speakers for which speaker feed signals will be rendered is a surround speaker or a height speaker;
determining, based at least in part on whether at least one reproduction speaker of the plurality of reproduction speakers for which speaker feed signals will be rendered is a surround speaker or a height speaker, an amount of decorrelation to apply to audio object signals corresponding to the audio object; and
performing a decorrelation process to apply the determined amount of decorrelation to the audio object signals corresponding to the audio object,
wherein the decorrelation process comprises, for each speaker feed signal, mixing the audio object signal and a decorrelated version of the audio object signal in accordance with a time-varying panning gain for the audio object signal and a time-varying panning gain for the decorrelated version of the audio object signal, the decorrelated version of the audio object signal being obtained by a decorrelator; and
wherein respective time-varying panning gains for the decorrelated version of the audio object signal for the plurality of speaker feed signals sum to zero, so that the contribution of the decorrelator cancels out when the speaker feed signals are downmixed.

41. The method of claim 40, wherein it is determined that no reproduction speaker of the plurality of reproduction speakers for which speaker feed signals will be rendered is a surround speaker or a height speaker and wherein determining the amount of decorrelation to apply involves determining that no decorrelation will be applied.

42. The method of claim 40, wherein determining the amount of decorrelation to apply is based, at least in part, on audio object position data corresponding to the audio object.

43. The method of claim 40, wherein the audio object metadata associated with at least some of the audio objects includes information regarding the amount of decorrelation to apply.

44. The method of claim 40, wherein determining the amount of decorrelation to apply is based, at least on part, on a user-defined parameter.

45. An apparatus, comprising:
an interface system; and
a logic system capable of:
receiving, via the interface system, audio data comprising audio objects, the audio objects comprising audio object signals and associated audio object metadata, the audio object metadata including at least audio object position data;
receiving reproduction environment data comprising an indication of a number of reproduction speakers in a reproduction environment and indications of reproduction speaker locations within the reproduction environment; and
rendering the audio objects into one or more speaker feed signals based, at least in part, on the audio object metadata, wherein each speaker feed signal corresponds to at least one of the reproduction speakers within the reproduction environment and wherein the rendering involves:
determining, based at least in part on audio object position data for an audio object among the audio objects, a plurality of reproduction speakers for which speaker feed signals will be rendered;
determining whether at least one reproduction speaker of the plurality of reproduction speakers for which speaker feed signals will be rendered is a surround speaker or a height speaker;
determining, based at least in part on whether at least one reproduction speaker of the plurality of reproduction speakers for which speaker feed signals will be rendered is a surround speaker or a height speaker, an amount of decorrelation to apply to audio object signals corresponding to the audio object; and
performing a decorrelation process to apply the determined amount of decorrelation to the audio object signals corresponding to the audio object,
wherein the decorrelation process comprises, for each speaker feed signal, mixing the audio object signal and a decorrelated version of the audio object signal in accordance with a time-varying panning gain for the audio object signal and a time-varying panning gain for the decorrelated version of the audio object signal, the decorrelated version of the audio object signal being obtained by a decorrelator; and
wherein respective time-varying panning gains for the decorrelated version of the audio object signal for the plurality of speaker feed signals sum to zero, so that the contribution of the decorrelator cancels out when the speaker feed signals are downmixed.

46. The apparatus of claim 45, wherein it is determined that no reproduction speaker of the plurality of reproduction speakers for which speaker feed signals will be rendered is a surround speaker or a height speaker and wherein determining the amount of decorrelation to apply involves determining that no decorrelation will be applied.

47. The apparatus of claim 45, wherein determining the amount of decorrelation to apply is based, at least in part, on audio object position data corresponding to the audio object.

48. The apparatus of claim 45, wherein the audio object metadata associated with at least some of the audio objects includes information regarding the amount of decorrelation to apply.

49. The apparatus of claim 45, wherein determining the amount of decorrelation to apply is based, at least on part, on a user-defined parameter.

50. The apparatus of claim 45, further comprising a memory system, wherein the interface system comprises an interface between the logic system and at least a portion of the memory system.

51. The apparatus of claim 45, wherein the interface system comprises a network interface.

52. An apparatus, comprising:
interface means for data communication; and
logic means for:
receiving, via the interface means, audio data comprising audio objects, the audio objects comprising audio object signals and associated audio object metadata, the audio object metadata including at least audio object position data;
receiving reproduction environment data comprising an indication of a number of reproduction speakers in a reproduction environment and indications of reproduction speaker locations within the reproduction environment; and
rendering the audio objects into one or more speaker feed signals based, at least in part, on the audio object metadata, wherein each speaker feed signal corresponds to at least one of the reproduction speakers within the reproduction environment and wherein the rendering involves:
determining, based at least in part on audio object position data for an audio object among the audio objects, a plurality of reproduction speakers for which speaker feed signals will be rendered;
determining whether at least one reproduction speaker of the plurality of reproduction speakers for which speaker feed signals will be rendered is a surround speaker or a height speaker;
determining, based at least in part on whether at least one reproduction speaker of the plurality of reproduction speakers for which speaker feed signals will be rendered is a surround speaker or a height speaker, an amount of decorrelation to apply to audio object signals corresponding to the audio object; and
performing a decorrelation process to apply the determined amount of decorrelation to the audio object signals corresponding to the audio object,
wherein the decorrelation process comprises, for each speaker feed signal, mixing the audio object signal and a decorrelated version of the audio object signal in accordance with a time-varying panning gain for the audio object signal and a time-varying panning gain for the decorrelated version of the audio object signal, the decorrelated version of the audio object signal being obtained by a decorrelator; and
wherein respective time-varying panning gains for the decorrelated version of the audio object signal for the plurality of speaker feed signals sum to zero, so that the contribution of the decorrelator cancels out when the speaker feed signals are downmixed.

53. The apparatus of claim 52, wherein it is determined that no reproduction speaker of the plurality of reproduction speakers for which speaker feed signals will be rendered is a surround speaker or a height speaker and wherein determining the amount of decorrelation to apply involves determining that no decorrelation will be applied.

54. The apparatus of claim 52, wherein determining the amount of decorrelation to apply is based, at least in part, on audio object position data corresponding to the audio object.

55. A non-transitory medium having software stored thereon, the software including instructions for controlling at least one apparatus to perform the following operations:
receiving audio data comprising audio objects, the audio objects comprising audio object signals and associated audio object metadata, the audio object metadata including at least audio object position data;
receiving reproduction environment data comprising an indication of a number of reproduction speakers in a reproduction environment and indications of reproduction speaker locations within the reproduction environment; and
rendering the audio objects into one or more speaker feed signals based, at least in part, on the audio object metadata, wherein each speaker feed signal corresponds to at least one of the reproduction speakers within the reproduction environment and wherein the rendering involves:
determining, based at least in part on audio object position data for an audio object among the audio objects, a plurality of reproduction speakers for which speaker feed signals will be rendered;
determining whether at least one reproduction speaker of the plurality of reproduction speakers for which speaker feed signals will be rendered is a surround speaker or a height speaker;
determining, based at least in part on whether at least one reproduction speaker of the plurality of reproduction speakers for which speaker feed signals will be rendered is a surround speaker or a height speaker, an amount of decorrelation to apply to audio object signals corresponding to the audio object; and
performing a decorrelation process to apply the determined amount of decorrelation to the audio object signals corresponding to the audio object,
wherein the decorrelation process comprises, for each speaker feed signal, mixing the audio object signal and a decorrelated version of the audio object signal in accordance with a time-varying panning gain for the audio object signal and a time-varying panning gain for the decorrelated version of the audio object signal, the decorrelated version of the audio object signal being obtained by a decorrelator; and
wherein respective time-varying panning gains for the decorrelated version of the audio object signal for the plurality of speaker feed signals sum to zero, so that the contribution of the decorrelator cancels out when the speaker feed signals are downmixed.

56. The non-transitory medium of claim 55, it is determined that no reproduction speaker of the plurality of reproduction speakers for which speaker feed signals will be rendered is a surround speaker or a height speaker and wherein determining the amount of decorrelation to apply involves determining that no decorrelation will be applied.

57. The non-transitory medium of claim 55, wherein determining the amount of decorrelation to apply is based, at least in part, on audio object position data corresponding to the audio object.

58. The non-transitory medium of claim 55, wherein the audio object metadata associated with at least some of the audio objects includes information regarding the amount of decorrelation to apply.

59. The non-transitory medium of claim 55, wherein determining the amount of decorrelation to apply is based, at least on part, on a user-defined parameter.
